(19) United States
(12) Patent Application Publication
(10) Pub. No.: US 2006/0092031 A1
(43) Pub. Date: May 4, 2006

(54) Building monitoring system

(76) Inventors: David E. Vokey, Bellingham, WA (US); Gamal Mustapha, Winnipeg (CA)

Correspondence Address: ADE & COMPANY INC., P.O. BOX 28006 1795 HENDERSON HIGHWAY, WINNIPEG, MB, R2G1P0, CA

(21) Appl. No.: 10/978,405

(22) Filed: Nov. 2, 2004

(51) Int. Cl. G08B 21/00

(52) U.S. Cl. 340/602

(57) ABSTRACT

A building monitoring system monitors selected zones in a building structure for the presence of moisture. The system uses multiple moisture detectors, each installed I the structure at a location to be monitored. A remote sensor unit is associated with each zone to be monitored and is coupled to the detectors in the associated zone. The sensor unit generates an alarm signal having a characteristic uniquely representing the sensor unit and any wet detector to pinpoint any leakage problem. A monitoring unit receives alarm signals from the sensor units, decodes the alarm signals and generates an alarm report reporting the existence and location of any leakage.

### FIELD OF THE INVENTION

The present invention relates to a system for monitoring structures for the presence of moisture. It has particular application to monitoring residential and commercial buildings for undesired water ingress.

### BACKGROUND

Buildings leak. Despite the best efforts of the architects and engineers who design them, the contractors who build them and the property managers who maintain them, water gets in and causes countless problems. In many cases the leaks go undetected as water penetrates through external barriers and channels into wall cavities where it remains unnoticed for months or even years. These wet environments become fertile places to grow molds that digest and destroy structural wood components and drywall materials. The tiny mold spores produced in the growth process often cause serious allergic reactions to occupants of the building.

Early detection and location of building envelope penetration will allow a builder or owner to identify developing problems and to carry out minor repairs. Homeowners, builders, and insurance companies can avoid high costs that are incurred from extensive structural damage, health problems, insurance claims and potential litigation.

Several water-leak detection systems are commercially available. These are designed to detect and to locate internal water leaks in typical flood-prone areas in buildings. The areas that are monitored typically include floors, appliances, plumbing fixtures and pipes where catastrophic failure of a water containing or conveying device or severe precipitation might cause flooding. While well suited for internal flood zone monitoring, none of the current systems are suited for long-term monitoring of the structural components of the building itself.

Commercially available leak-detection systems all operate on the principle of applying a measuring voltage to a pair of conductors that form a water detection element. A water bridge between the conductors forms a resistive path thereby completing the sensing circuit. A current then develops through the water bridge and is sensed and reported by the leak detection system.

With this type of sensing element, the current passing from one conductor to the other through the water path causes an electrolysis reaction that corrodes the conductors. The rate of corrosion is proportional to the magnitude and duration of the current. If the duration is long enough, the sensing conductors can corrode through and result in a failure of the sensor. This is generally not an issue for internal flood zones in a building as the flood area is generally accessible, any flooding is relatively short term and the detector element can readily be dried out or replaced.

A building structure monitoring system must be designed with detector components built into wall cavities, floors, ceilings and roofs and have an operating life that exceeds the life expectancy of the building being monitored.

### SUMMARY

The present invention proposes a means whereby moisture detectors can be integrated into a building structure to monitor for water ingress, with the detectors having an expected service life that exceeds the lifetime of the building structure.

According to the present invention, there is provided a building monitoring system for monitoring selected zones in a building structure for the presence of moisture, said system comprising:

a plurality of moisture detectors, each having a detector parameter with a dry value in the absence of moisture and a different, wet value in the presence of moisture;

a sensor unit associated with each said zone, each sensor unit being coupled to one or more of the detectors in the associated zone, the sensor unit being operable being to generate an alarm signal having a characteristic uniquely representing the sensor unit in response to any of the detectors to which it is coupled having a wet parameter value;
a monitoring unit for receiving alarm signals from the sensor units, decoding each alarm signal received and generating an alarm report reporting the existence of an alarm signal and the identity of the sensor unit generating the alarm signal.

The currently preferred embodiments of the invention include a monitoring circuit connecting the remote sensors for delivering power and actuation signals to the sensors and delivering alarm signals from the sensor units to the monitoring unit. It is also possible to provide wireless communication between the sensor units and the monitoring unit, but an alternative sensor powering system would be required.

This system allows the identification of the presence of moisture at any location in the building where a detector is located, allowing maintenance personnel to identify and ameliorate leakage before it becomes a problem.

It is preferred to configure the sensor to report the identity of each detector that is detecting moisture to identify a particular monitored zone as the location of the moisture.

The moisture detectors may be moisture detectors as disclosed in commonly owned U.S. patent application Ser. No. 60/488,090, filed Jul. 18, 2003, and the international patent application claiming priority therefrom. The entire contents of both applications are incorporated herein by reference. These detectors include tapes constructed with a pair of copper conductors laid parallel on a dielectric substrate. In a dry state the detection tape appears as an open circuit. Water bridging the space between the conductors will produce a conductive path between the conductors having a resistance in the order of a few thousand ohms or less, the detector parameter is in this case electrical resistance, although other parameters, particularly electrical parameters may be used depending on the design of the detectors. As described in the earlier patent applications, the detectors may also include substrate penetrating probes for detecting absorbed moisture in structural components. The detectors, sensor units and monitoring circuit are installed in the building structure at the time of construction and remain in place for the life of the structure.

Each sensor unit may assigned to a particular building area, with the associated detector tapes located at respective critical zones where water problems may occur within that area.

In the currently preferred embodiments of the system, the sensor units are connected in series in the monitoring circuit. When generating an alarm signal, each sensor unit includes in the alarm an address code uniquely identifying the sensor unit. Additionally; several alarm signals representing respective detectors may be multiplexed by each sensor unit that reports back to the monitoring unit to identify the precise problem zone or zones in the building structure. In the currently preferred embodiments, up to one hundred sensor units can be placed on a single monitoring circuit, thus enabling the monitoring of a large number of zones in various building areas, each with a unique digital code.

The computer-controlled monitoring unit applies a low voltage powering dc across the monitoring circuit to energize the sensor units. The same circuit is used to receive the coded alarm signals from the sensor units and to test for continuity and functionality of the circuit.

Once energized, a sensor unit applies a measuring voltage to the moisture-detection conductors. Any conductive path in a detector with a resistance that is below a predetermined value will cause the remote-zone sensor to report the zone code assigned to that detector back to the monitoring unit. The zone code is unique and is linked to a database preprogrammed into the monitoring unit to correlate the zone codes and the monitored zones. An alarm report is then generated by the monitoring unit detailing the exact location in the building requiring attention.

The point of the water entry can then be located and a repair can be carried out. The zone will then dry out and the alarm condition is ended.

The moisture detection tape, which is integrated into the building structure, remains in place to monitor any further water ingress.

As noted above, the service life of the moisture detector tape should at least equal the useful life of the building being monitored. This raises the question of conductor corrosion.

Metal conductors immersed in water and subjected to an electrical current will undergo electrolysis and corrosion. The corrosion rate varies with the type of metal conductors and is in a range of 2 to 10 kg per ampere per year. A moisture fault current as little as 50×10⁻⁶ ampere can result in a localized corrosion of 2 to 10 grams of conductor metal in 10 years. This will corrode and destroy almost a meter of 22 gauge copper conductor.

The monitoring unit addresses this problem by limiting the duty cycle of the detection conductors thereby minimizing the detection conductor corrosion over service life of the monitored building. The duty cycle is defined as the ratio of the time period during which the detection conductors are electrically energized divided by the total time for a complete cycle.
D=E/T×100

Where:

D is the duty cycle in %;

E is the energization time, that is the time that the detector conductors are energized in a single cycle, in seconds; and

T is the cycle period, that is duration of a cycle, in seconds.

The cycle period T must be sufficiently short that an event does not go undetected for an unacceptably long time and the energization time E during which the detection conductors are electrically energized must be sufficiently long that an event is detected and reported.

The present invention preferably uses as detectors the moisture detection tape and probes of the above mentioned patent applications. Each tape is connected to a sensing input of a remote zone sensor that assigns a digitally coded address to the zone to be monitored. The remote zone sensor reports over a pair of monitoring conductors to a computer based monitoring system. The monitoring system energizes the monitoring conductors and checks for alarm signals at regular intervals as determined by the preprogrammed duty cycle.

### BRIEF DESCRIPTION OF THE DRAWINGS

In the accompanying drawings, which illustrate an exemplary embodiment of the present invention:

FIG. 1 is an overall illustration of the system showing the connection of the monitoring computer to the network of remote zone sensors;

FIG. 2 is a block diagram of a remote zone sensor;

FIG. 3 is a block diagram of a system monitoring computer; and

FIG. 4 is a block flow chart of the basic software for the monitoring computer.

### DETAILED DESCRIPTION

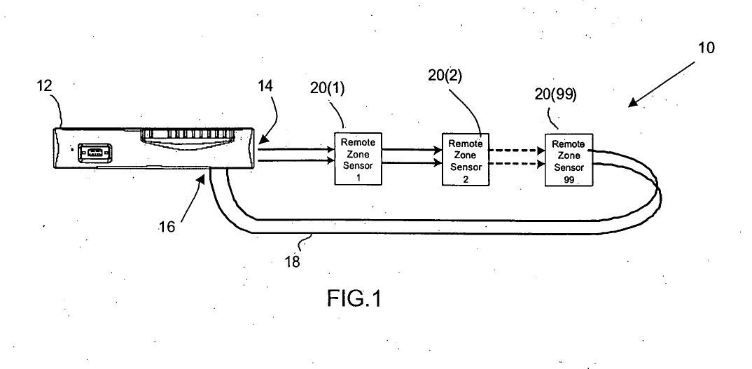

Referring to the accompanying drawings, and particularly to FIG. 1, a computer based monitoring system 10 includes a computer 12 connected to upstream and downstream ends 14 and 16 respectively of a monitoring circuit 18. A number of remote zone sensors 20, designated 20(1) . . . 20(99) respectively, that are connected in series in the circuit 18. As discussed in more detail in the following, the computer 12 actuates the remote zone sensors 20 at specific intervals as determined by a pre-programmed duty cycle. In the event that moisture is detected by a detector connected to a remote zone sensor 20 as described in the following, the sensor transmits to the monitoring computer an alarm signal including a digital code unique to the detector in question. The monitoring computer records an alarm and accesses a database which cross references the detector codes with the detector locations in the building. The computer then issues an alarm report detailing the exact location in the building requiring attention.

The monitoring circuit 18 is looped back to the downstream end 16 at the monitoring computer 12 so that a continuity check of the circuit may be performed. In the event that a discontinuity is detected, the computer records the event and issues an alarm report to notify the appropriate personnel.

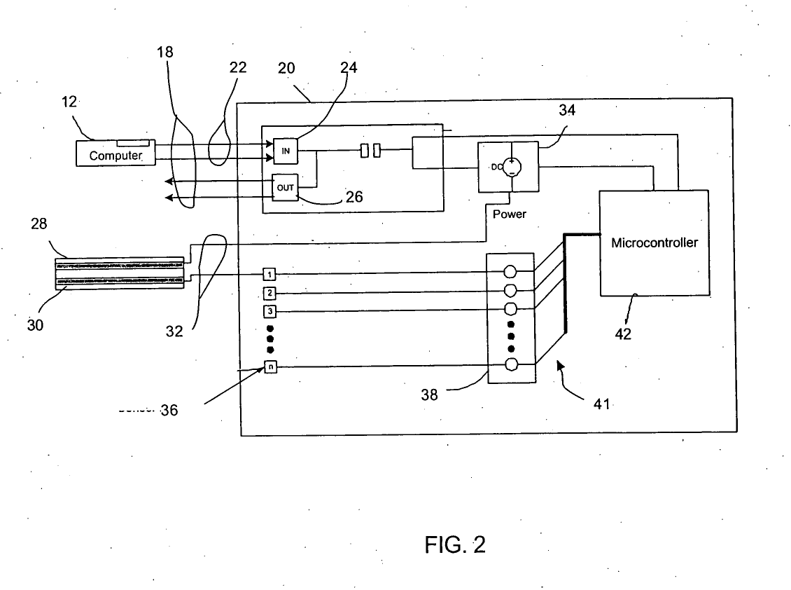

As illustrated in FIG. 2, the circuit 18 includes a two wire conductor 22 connecting the monitoring computer 12 serially to the input 24 of remote zone sensor 20 (1), the output 26 of which in turn connects serially to the adjacent remote zone sensor 20 (2) and so on. The encoding technology used by these sensors allows hundreds of remote zone sensors to be deployed on a single serial line. Depending on the number of remote zone sensors required, the monitoring computer can be configured to accommodate multiple lines by time sharing the lines at specific intervals as determined by a preprogrammed duty cycle. Moisture detectors 28 (one shown) in the form of moisture detection tape 30 connected using respective two wire conductors 32 to a sensor power supply 34 and to respective ones of sensor inputs 36 of the remote zone sensor 20. The sensor inputs are in turn connected to a triggering circuit 38 Once the moisture detection tape absorbs water, a remote zone sensor triggering circuit 38 will sense a change in resistance and will trigger once the required moisture level has been detected. The trigger outputs 40 are input to a microcontroller 42. Once it has received an output from the trigger, the remote zone sensor microcontroller 42 will transmit a digital code to the monitoring computer 12. The encoding scheme used is based on the Statistically Independent Sensor Unit (SISU) technology proprietary to Norscan Instruments Ltd. By utilizing the SISU encoding scheme, multiple remote zones sensors can be triggered simultaneously and decoded. The transmitted code includes a component identifying the specific remote zone sensor 20 and another component identifying specific detector inputs that have triggered the sensor

The monitoring computer 12 provides a user interface to the multiple arrays of remote zone sensors and collects and processes all alarm events. The computer automates the monitoring process by collecting data on all alarms, processing the data and forwarding the compiled results to the user.

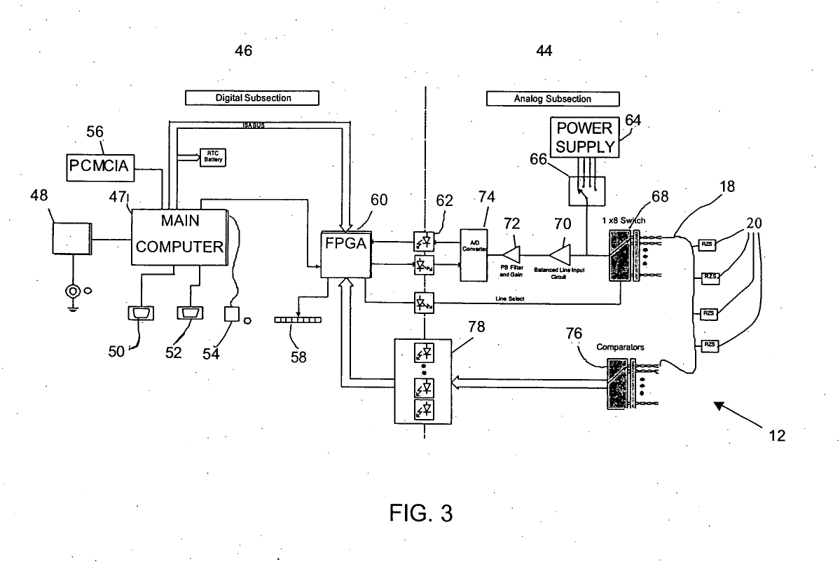

Referring to FIG. 3, the computer 12 includes an analog and digital subsections 44 and 46 respectively. The sections are electrically isolated for noise reduction purposes.

Digital Subsection

The digital subsection includes a main computer 47. It is powered by an external power supply 48. The computer 47 has an RS232 port 50 for local access, a secondary RS232 port 52 for future expansion modules, a 10/100 BaseT port 54 for Ethernet support and a PCMCIA slot 56 to accommodate other connection media, for example modems and wireless network cards. The status of each line is displayed using multicolored LEDs 58 representing the respective lines. All discrete logic to the analog subsection 44 is implemented in a Field Programmable Gate Array (FPGA) 60.

Analog Subsection

The analog subsection 44 is electrically isolated from the digital section for noise reduction purposes. The method used to transfer data to and from the FPGA on the digital section is through optically isolated relays 62. The power supply for the analog section is an isolated power supply 64 connected through a voltage reversing switch 66. Reversing the voltage is useful for some diagnostic procedures. The communication interface and power is supplied to multiple monitoring circuits 18 using a switching array 68. The external lines are interfaced using a balanced line input circuit 70, the output of which passes through a filter and gain stage 72 and is then routed to an analog to digital converter 74 for transmission to the digital section 46. All data is queued in the FPGA 60 and then passed to the main computer 47 for analysis. Once a line 18 is powered, any remote zone sensor in alarm will transmit its code that will ultimately be decoded and processed accordingly. In addition to processing sensor alarms the system performs a continuous continuity check to ensure the entire loop is continuous. The continuity check is performed by checking if a voltage is present using a comparator circuit 76 connected to the end 16 of the circuits 18. The result is then transferred to the FPGA via the optical isolation relays 78.

Software Subsystem

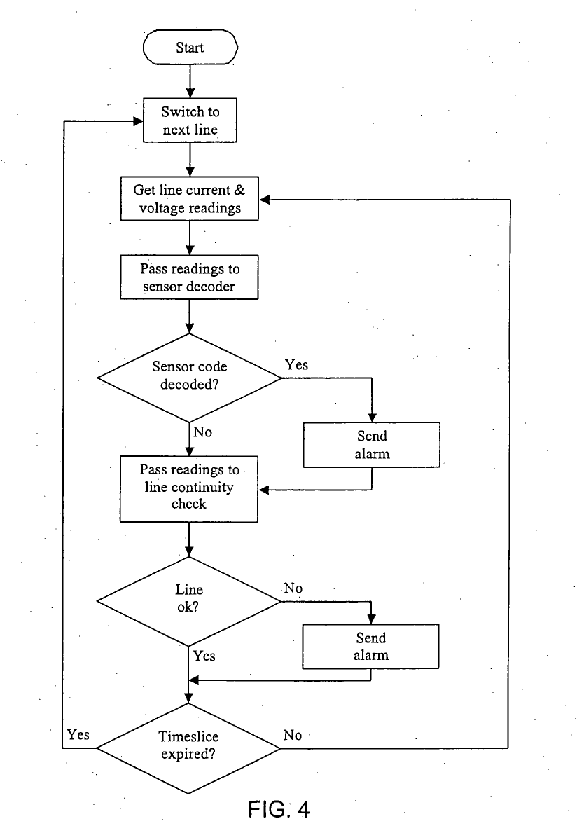

The software subsystem automates the structure monitoring system by processing alarms and interfacing the user to the collected data and events. The system energizes the remote monitoring circuits 18 at specific intervals as determined by a pre-programmed duty cycle. Once a circuit is energized, the software fetches A/D readings through the FPGA and decodes any sensor codes that may be present. Once decoded, an alarm is recorded and forwarded to pre-programmed reporting locations. In addition to sensor decoding, continuity alarms are also processed. The basic monitoring algorithm is displayed in the flowchart in FIG. 4.

Sensors used for flood zone monitoring are not required to be scanned according to a specific duty cycle for corrosion prevention purposes since these sensors are in locations that are not prone to constant moisture exposure, which promotes corrosion. The software duty cycle for those sensors can be modified so that flood zones are scanned more frequently and reported immediately to the appropriate personnel.

The monitoring computer contains a database where all sensors 20 and detectors 28 are described as to what they are monitoring and where they are located. In the event of an alarm, the sensor code is cross referenced with the information in the database and a detailed report is generated and forwarded to the user. The user can program the system to send report summaries at specific times and delivered to specific targets. The system is capable of forwarding reports and interfacing the user through various methods. Reports can be forwarded by Email, SMS, Modem, Pager or SNMP. The software system can be accessed by a web interface over Ethernet or console connection over Ethernet, modem or serial port.

As a result of the large number of sensor inputs the system is capable of handling, a high level of automation and alarm processing is required. The software is capable of tracking and logging the location and time of all alarm occurrences. The software can then classify the severity of an alarm depending on the persistence of the alarm and the time frame over which it occurred.

While one embodiment of the present invention has been described in the foregoing, it is to be understood that other embodiments are possible within the scope of the invention. For example, while the monitoring circuit, is described as a hard wired, two conductor circuit, other forms of communication are possible, including wireless communication, although this would require an alternative power supply for each sensor. The invention is therefore to be considered limited solely by the scope of the appended claims.

Embodiments of the invention in which an exclusive property or privilege is claimed are defined as follows:

1. A building monitoring system for monitoring selected zones in a building structure for the presence of moisture, said system comprising:
a plurality of moisture detectors, each having a detector parameter with a dry value in the absence of moisture and a different, wet value in the presence of moisture;
a sensor unit associated with each said zone, each sensor unit being coupled to one or more of the detectors in the associated zone, the sensor unit being operable to generate an alarm signal having a characteristic uniquely representing the sensor unit in response to any of the detectors to which it is coupled having a wet parameter value; and
a monitoring unit for receiving alarm signals from the sensor units, decoding each alarm signal received and generating an alarm report reporting the existence of an alarm signal and the identity of the sensor unit generating the alarm signal.

2. A system according to claim 1 including a monitoring circuit connecting the sensor units and the monitoring unit for delivering alarm signals from the sensor units to the monitoring unit.

3. A system according to claim 2 wherein the monitoring unit includes sensor actuating means for delivering electrical power to the sensors over the monitoring circuit.

4. A system according to claim 2 including a plurality of monitoring circuits connecting different groups of sensor units.

5. A system according to claim 4 wherein the monitoring unit includes means for selectively transmitting actuation signals to the respective monitoring circuits.

6. A system according to claim 1 wherein each sensor is configured to generate alarm signals having a characteristics uniquely representing the identity of each detector to which it is coupled having a wet parameter value.

7. A system according to claim 1 wherein each detector comprises a tape including a pair of electrical conductors on a dielectric substrate, the detector parameter being electrical resistance between the conductors.

8. A system according to claim 6 wherein the monitoring unit includes a database correlating the alarm signal characteristics and the location of in the building structure of each detector with a wet parameter value.

9. A system according to claim 3 wherein the monitoring unit includes means for selectively delivering electrical power to the sensors according to a predetermined duty cycle.

10. A system according to claim 2 wherein the monitoring unit includes means for monitoring the continuity of the monitoring circuit.
